(19) United States
(12) Patent Application Publication
(10) Pub. No.: US 2010/0107414 A1
(43) Pub. Date: May 6, 2010

(54) METHOD AND APPARATUS FOR MANUFACTURING GRATING

(75) Inventor: Kyu-hwan Park, Gwangmyeong-si (KR)

Correspondence Address: Jae Y. Park, Kile, Goekjian, Reed & McManus, PLLC, 1200 New Hampshire Ave. NW, Suite 570, Washington, DC, 20036, US

(73) Assignee: ALUMINIUM PLAZA CO., LTD., Ansan-si, Gyeonggi-do (KR)

(21) Appl. No.: 12/593,613

(22) PCT Filed: Apr. 24, 2008
(86) PCT No.: PCT/KR2008/002314

§ 371 Date: Sep. 29, 2009

(30) Foreign Application Priority Data
Apr. 27, 2007 (KR) 10-2007-0041182

(51) Int. Cl. B23P 15/12; E03F 5/06

(52) U.S. Cl. 29/897.15; 29/700

(57) ABSTRACT

The present invention provides a method of manufacturing a grating. The method of the present invention includes fitting a plastic deformable lateral member (2) having a hollow pipe shape into coupling holes (10) formed through respective longitudinal members (4) in a lateral direction of the longitudinal members; holding the lateral member and the longitudinal members; and passing a forming weight (12) through the lateral member (2) from a first end of the lateral member to a second end thereof using a relatively large external force. Here, the forming weight has a predetermined size suitable for passing through the lateral member to expand the cross-sectional area of the lateral member such that the lateral member is plastic-deformed.

### TECHNICAL FIELD

The present invention relates, in general, to gratings and, more particularly, to a method and an apparatus for manufacturing a grating having a lattice shape.

### BACKGROUND ART

In general industrial fields, gratings are lattice-shaped covers and are used for various purposes, for example, as covers for manholes, covers for subway vents provided in footways, stairs, footboards, etc. FIG. 1 illustrates a representative example of such conventional gratings.

As shown in the drawing, a grating 100 includes an outer frame 102, and lateral members 104 and longitudinal members 106, which are arranged inside the outer frame 102 at relatively close intervals in lateral directions and longitudinal directions to have a lattice shape. A linear steel bar having a twisted shape to increase the tensile strength thereof is used as each lateral member 104. Each longitudinal member 106 typically has a longitudinal plate shape, which has an I-shaped cross-section. Each longitudinal member 106 has in the upper edge thereof insert notches, which are formed at positions spaced apart from each other in the longitudinal direction at predetermined intervals, and into each of which a corresponding lateral member 104 is fitted.

Typically, the lateral members 104 and the longitudinal members 106 are perpendicular to each other, and they are fixed to each other by welding at the junctions therebetween. Gratings made of stainless steel can be mass-produced using an automatic resistance welding method. However, in the case of nonferrous metals such as aluminum and copper, it is difficult to use the resistance welding method. Thus, in the case where nonferrous metals are used as the material for a grating, a welding process must be separately conducted for every junction. This is not easy. Even though the grating is completed through such welding processes, if a relatively large load is applied to the grating, or, after it is used for a long period time, welded portions may be separated from each other, thus deteriorating the external appearance of the grating and causing noise. In addition, the separated portions may be potentially dangerous to pedestrians.

In an effort to overcome the above problems, as shown in the sectional view of FIG. 2, a grating, in which rod-shaped lateral members 104 are fitted into corresponding coupling holes 106a formed through longitudinal members 106, was proposed. A spacer 108 having a pipe shape is interposed between adjacent longitudinal members 106 to maintain the gap between the adjacent longitudinal members 106 constant. This grating has an advantage in that a welding process is unnecessary. However, there is a disadvantage in that it is inconvenient to alternately fit the large number of spacers 108 and the longitudinal members 106 over the lateral members 104, and the cost of manufacturing the grating increases due to the addition of elements.

### DISCLOSURE OF INVENTION

### Technical Problem

Accordingly, the present invention has been made keeping in mind the above problems occurring in the prior art, and an object of the present invention is to provide a method and an apparatus for manufacturing a grating, having a plurality of lateral members and a plurality of longitudinal members which are coupled to each other in a lattice shape, the method and the apparatus being able to solve the problem of separation of the lateral members and the longitudinal members at junctions and making the coupling between the elements easy, thus reducing the cost of manufacturing the grating.

### Technical Solution

In order to accomplish the above object, in an aspect, the present invention provides a method of manufacturing a grating, including: fitting a plastic deformable lateral member having a hollow pipe shape into coupling holes, formed through respective longitudinal members, in a lateral direction of the longitudinal members; holding the lateral member and the longitudinal members; and passing a forming weight through the lateral member from a first end of the lateral member to a second end thereof using external force, the forming weight having a predetermined size suitable for passing through the lateral member to expand a cross-sectional area of the lateral member such that the lateral member is plastic-deformed, so that the lateral member is force-fitted to inner surfaces of the coupling holes of the longitudinal members, thus fixing the lateral member to the longitudinal members. Preferably, each of the lateral members and the longitudinal members may be made of aluminum or an aluminum alloy.

In another aspect, the present invention provides an apparatus for manufacturing a grating, including: a holding means for maintaining a state in which plastic deformable lateral members, each having a hollow pipe shape, and longitudinal members having coupling holes, into which the lateral members are fitted in directions of the longitudinal members, are assembled with each other in a lattice shape; forming weights, each having a size suitable for passing through the corresponding lateral member to expand a cross-sectional area of the lateral member such that the lateral member is plastic-deformed; a tensioning device to pull the forming weights using tensile force; and tension rods placed through the respective lateral members, the tension rods being removably coupled at first ends thereof to the tensioning device and being coupled at second ends thereof to the respective forming weights. Here, each of the lateral members and the longitudinal members may be made of aluminum or an aluminum alloy.

Preferably, the tensioning device may comprise one selected from between a hydraulic cylinder and a pneumatic cylinder, which generates linear motion and is easily controlled.

### Advantageous Effects

A method and an apparatus for manufacturing a grating according to the present invention can markedly enhance productivity through the elimination of an operation of welding a large number of junctions between lateral members and longitudinal members. In addition, the method and apparatus of the present invention can solve a problem of separation of the lateral members from the longitudinal members, ensure a superior appearance of the grating, and reduce the cost of manufacturing the grating.

### BRIEF DESCRIPTION OF THE DRAWINGS

FIG. 1 is a perspective view of a conventional grating;

FIG. 2 is a sectional view of another conventional grating;

FIG. 3 is sectional views illustrating steps of a process of manufacturing a grating, according to an embodiment of the present invention;

FIG. 4 is a perspective view illustrating a step of coupling an outer frame to an assembly body of lateral members and longitudinal members according to the present invention;

FIG. 5 is a sectional view showing the coupling between a lateral member and longitudinal members, according to another embodiment of the present invention;

FIG. 6 is a side view showing an apparatus for manufacturing a grating, according to an embodiment of the present invention; and

FIG. 7 is a perspective view of the grating manufacturing apparatus of FIG. 6.

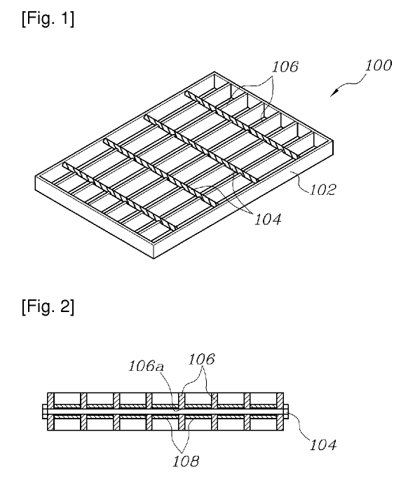

### BEST MODE FOR CARRYING OUT THE INVENTION

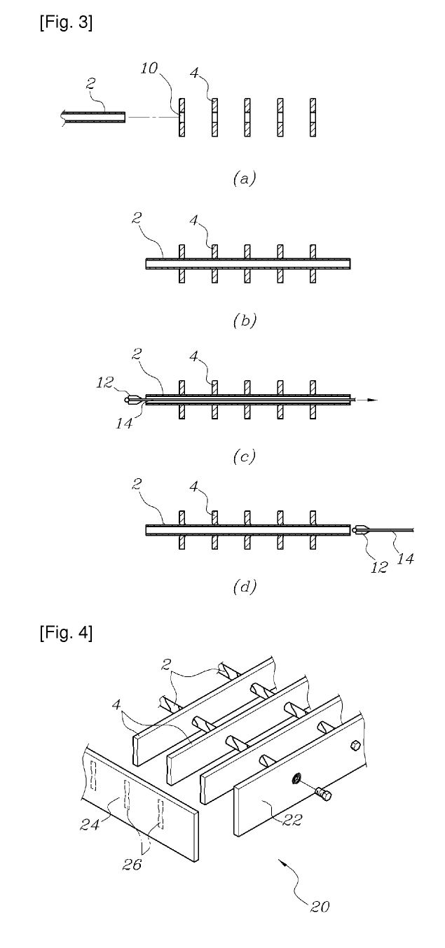

Hereinafter, preferred embodiments of the present invention will be described in detail with reference to the attached drawings. FIG. 3 is views illustrating steps of a process of manufacturing a grating, according to an embodiment of the present invention.

In the embodiment, each lateral member 2 has a hollow pipe shape. Each longitudinal member 4 has a longitudinal plate shape having an I-shaped cross-section. Several coupling holes 10 are formed through the longitudinal member 4 at positions spaced apart from each other in a longitudinal direction at regular intervals. Each of the lateral members 2 and the longitudinal members 4 is made of aluminum, an aluminum alloy or stainless steel.

The lateral member 2 preferably has a circular shape when viewed in cross-section, but is not necessarily limited to this. The cross-section of the lateral member 2 has the same shape as the coupling hole 10. The lateral member 2 has a diameter corresponding to the size of the corresponding coupling hole 10 to have an appropriate clearance such that the lateral member 2 can be inserted into the coupling hole 2 without large resistance. The lateral member 2 is firmly friction-coupled to the coupling hole 10 by expanding the cross-section of the lateral member 2, and this will be explained in detail later herein.

As shown in FIG. 3a, each lateral member 2 is inserted into the corresponding coupling holes 10 in the longitudinal members 4. That is, the longitudinal members 4 are fitted over the lateral members 2 such that the longitudinal members 4 maintain regular intervals therebetween, thus forming a lattice shape, as shown in FIG. 3b.

The lateral members 2 and the longitudinal members 4 are fixed to each other in the state of FIG. 3b. Thus, a jig or a holding means for this purpose must be provided.

To achieve the above purpose, a forming weight 12, which has a size appropriate to pass through each lateral member 2 and expand the cross-sectional area of the lateral member 2 such that the lateral member 2 having the pipe shape is plastic-deformed, is coupled to an end of a wire 14 having high tension resistance. It is preferable that the forming weight 12 have a tapered shape, the cross-section of which is increased from one end thereof to the other end thereof, as shown in the drawing. The cross-section of the forming weight 12 has the same shape as that of the coupling hole 10 and the lateral member 2, and the maximum cross-sectional area thereof is larger than the cross-sectional area defined by the inner diameter of the lateral member. For example, in the case where the lateral member 2 and the forming weight 12 have square cross-sections, one side of the forming weight 12 (in the case where they have circular cross-sections, the diameter of the forming weight 12) is from 0.5 mm to 2 mm longer than that of the lateral member 2.

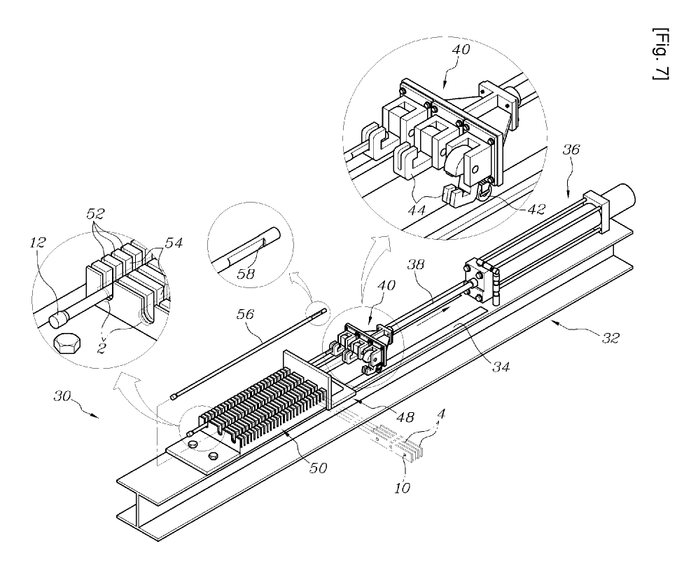

The forming weight 12 and the wire 14 are coupled to each other by inserting the wire 14 into a hole, which is formed through the center of the forming weight 12, and by knotting a first end of the wire 14. A second end of the wire 14 is coupled to a tensioning device (see FIGS. 6 and 7). In the state of FIG. 3c, when the wire 14 is strongly pulled to the right, the forming weight 12 passes through the lateral member 2 and expands the inner diameter, that is, the cross-section area, of the lateral member 2. FIG. 3d shows the state in which the lateral member 2 and the longitudinal members 4 are coupled to each other by frictional force after the forming weight 12 passes through the lateral member 2. If necessary, the forming weight 12 and the wire 14 may be integrated with each other into a single body. In this case, an inflexible tension rod (56, see FIG. 6 or 7) may be used as the wire 14.

As such, while the forming weight 12 forcibly passes through the lateral member 2, the sidewall of the lateral member 2 is brought into close contact with and is fixed to the corresponding coupling holes 10 in the longitudinal members.

In the grating of the present invention, most of the load transmitted to the upper surface of the grating in a downward direction is applied to the longitudinal members 4. The lateral members 2 mainly serve to maintain regular intervals between the longitudinal members 4. Therefore, the lateral members 2 have little relation to the load. However, because the possibility of application of a very large load to the upper surface of the grating cannot be excluded, a reinforcing member (not shown) may be selectively inserted into each hollow lateral member 2 to reinforce the grating. A twisted linear steel rod, used in the conventional technique, a simple rod or pipe may be used as each reinforcing member.

FIG. 4 is a perspective view illustrating a step of coupling an outer frame 20 to a lattice assembly body of the lateral members 2 and the longitudinal members 22. According to the intended purpose of a product, the installation of the outer frame 20 may be a selective item. The outer frame 20 has a longitudinal plate shape and includes longitudinal frames 22, which are coupled to the lateral members 2, and lateral frames 24, which are coupled to longitudinal members 4. In this embodiment, each longitudinal frame 22 may be coupled to the lateral members 2 by a welding or a bolt coupling method (the method shown in FIG. 4) or by a compression coupling method using pipe enlargement in the same manner as in FIG. 3. Each lateral frame 24 may be united to the longitudinal members 4 by welding or by a combination of welding and convexo-concave coupling. Here, the term “convexo-concave coupling” means a coupling method in which depressions 26, each of which has a shape corresponding to the cross-section of the corresponding longitudinal member 4, are formed in the lateral frame 24, and the longitudinal members 4 are fitted into the respective depressions 26. In the convexo-concave coupled state, the welding operation may be selectively conducted.

Furthermore, the installation of the frames 22 and 24 can be conducted by various methods, but this is not the main point of the present invention.

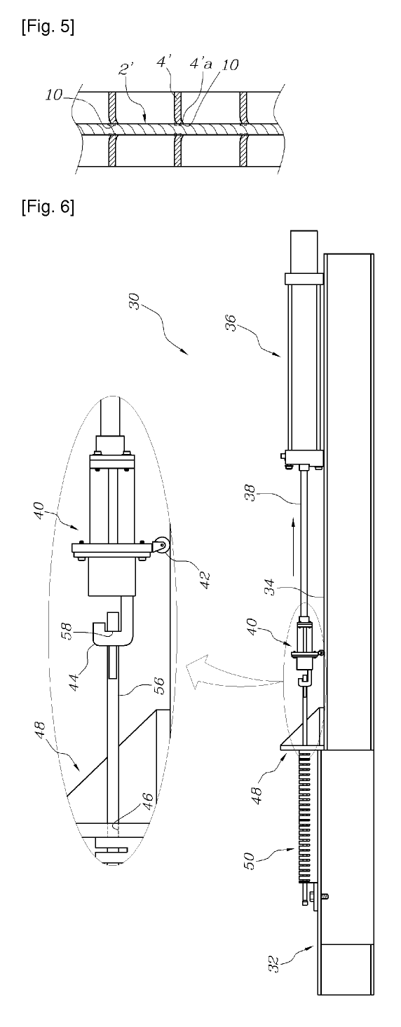

Another embodiment of the present invention is shown in FIG. 5. In this embodiment, each lateral member 2′ is made of a twisted linear member having a circular cross-section. Each longitudinal member 4′ has coupling holes 10, each of which has an area (shown by the dashed line) less than the cross-sectional area of the lateral member 2′. Thus, the lateral member 2′ is force-fitted into the corresponding coupling holes in the longitudinal members 4′, so that the lateral member 2′ is compression-coupled to the longitudinal members 4′. In the force-fitted state, as shown in the drawing, perimeters 4′a of the coupling holes 10 of the longitudinal members 4′ are bent in the direction in which the lateral member 2′ is fitted into the coupling holes 10.

In a modification of this embodiment, the present invention may be constructed such that a screw rod is used as each lateral member 2′ and an internal thread is formed in the inner surface of each coupling hole 10 of the longitudinal member 4′ by tapping, so that the lateral member 2′ is screwed into the longitudinal members 4′.

Hereinafter, an apparatus for manufacturing a grating according to an embodiment of the present invention will be described with reference to FIGS. 6 and 7.

The grating manufacturing apparatus 30 is horizontally placed on the ground using a base frame 32 thereof. In this embodiment, the grating manufacturing apparatus 30 is constructed such that three lateral members 2 are coupled to a plurality of (for example, ten to twenty) longitudinal members 4.

The base frame 32 provides a rail 34. A tensioning device 36 is provided at a predetermined position on the base frame 32. In the embodiment, a hydraulic cylinder (or a pneumatic cylinder), which generates linear motion, is easily controlled, and is relatively quiet, is used as the tensioning device 36. A movable block 40, which is provided so as to be movable along the rail 34, is coupled to the end of a piston 38 of the tensioning device 36. The movable block 40 is movable along the rail 34 using wheels 42.

Three holders 44, which are parallel to each other, are provided in the movable block 40. A stop plate 48, through which three through holes 46 are formed at positions spaced apart from each other at regular intervals, is provided on the base frame 32 ahead of the tensioning device 36 in the direction perpendicular to the rail 34. The stop plate 48 serves to prevent the lateral members 2 from moving in longitudinal directions during the process of coupling the lateral members 2 to the longitudinal members 4.

Furthermore, a support block 50 is fastened to the base frame 32 ahead of the stop plate 48 in the same plane as the rail 34. A plurality of longitudinal slots 52, into which the respective longitudinal members 4 are inserted, is formed in the support block 50. Three lateral slots 54 are formed in the support block 50 in a direction perpendicular to the longitudinal slots 52. That is, the stop plate 48 and the support block 50 serve as a means for holding the lateral members 2 and the longitudinal members 4.

A coupling means, which passes through the lateral members 2, is removably coupled at a first end thereof to the tensioning device 36, in detail, to the holder 44, and is coupled at a second end thereof to the forming weight 12. In this embodiment, a tension rod 56, which is integrally formed with the forming weight 12, is used as the coupling means. As described above, a wire may be substitute for the tension rod 56.

A holding part 58, which is held by the holder 44, is formed in the rear end of each tension rod 56 by cutting part of the tension rod 56.

After the lateral members 2 and the longitudinal members 4 are set in the support block 50, the tension rods 56, each of which is provided with the forming weights 12, are inserted into the lateral members 2, and the rear ends of the tension rods 56 are held by the holder 44. Thereafter, when the tensioning device 36 is operated, the forming weights 12 pass through the corresponding coupling holes 10 in the lateral members 2. In this process, the inner diameters of the coupling holes 10 are increased. Thereby, the lateral members 2 are coupled to the longitudinal members 4. Preferably, a removal prevention means for preventing the longitudinal members 4 from being removed from the support block 50 upwards during the operation of the tensioning device 36 is provided, although this is not shown in the drawings.

### INDUSTRIAL APPLICABILITY

As described above, in a grating having a structure such that lateral members and longitudinal members are coupled to each other in a lattice shape, the present invention provides a method and an apparatus for manufacturing the grating which can markedly enhance productivity through the elimination of an operation of welding a large number of junctions between the lateral members and the longitudinal members. The method and apparatus of the present invention can solve a problem of separation of the lateral members from the longitudinal members, ensure a superior appearance of the grating, and reduce the cost of manufacturing the grating.

1. A method of manufacturing a grating, comprising: fitting a plastic deformable lateral member having a hollow pipe shape into coupling holes, formed through respective longitudinal members, in a lateral direction of the longitudinal members; holding the lateral member and the longitudinal members; and passing a forming weight through the lateral member from a first end of the lateral member to a second end thereof using external force, the forming weight having a predetermined size suitable for passing through the lateral member to expand a cross-sectional area of the lateral member such that the lateral member is plastic-deformed, so that the lateral member is force-fitted to inner surfaces of the coupling holes of the longitudinal members, thus fixing the lateral member to the longitudinal members.

2. The method according to claim 1, wherein each of the lateral members and the longitudinal members is made of aluminum or an aluminum alloy.

3. An apparatus for manufacturing a grating, comprising: holding means for maintaining a state in which plastic deformable lateral members, each having a hollow pipe shape, and longitudinal members having coupling holes, into which the lateral members are fitted in directions of the longitudinal members, are assembled with each other in a lattice shape; forming weights, each having a size suitable for passing through the corresponding lateral member to expand a cross-sectional area of the lateral member such that the lateral member is plastic-deformed; a tensioning device to pull the forming weights using tensile force; and tension rods placed through the respective lateral members, the tension rods being removably coupled at first ends thereof to the tensioning device and being coupled at second ends thereof to the respective forming weights.

4. The apparatus according to claim 3, wherein each of the lateral members and the longitudinal members is made of aluminum or an aluminum alloy.

5. The apparatus according to claim 3, wherein the tensioning device comprises one selected from between a hydraulic cylinder and a pneumatic cylinder.
